(19) United States
(12) Patent Application Publication
(10) Pub. No.: US 2003/0231945 A1
(43) Pub. Date: Dec. 18, 2003

(54) Shopping cart mover

(76) Inventor: Mason C. Weatherly, Myrtle Beach, SC (US)

Correspondence Address: SARA A. CENTIONI, ESQUIRE, NEXSEN PRUET JACOBS & POLLARD, LLC, PO DRAWER 2426, COLUMBIA, SC, 29202-2426, US

(21) Appl. No.: 10/171,030

(22) Filed: Jun. 12, 2002

(51) Int. Cl. B66F 1/00

(52) U.S. Cl. 414/604

(57) ABSTRACT

A driven, motorized vehicle adapted to transport a row of nested shopping carts. The transport vehicle pulls the carts behind it through the use of a securing means located in the body of the vehicle. The transport vehicle further includes an alignment member extending from the rear of the vehicle that keeps the nested carts in a favorable arrangement during the transport. The cabin area of the vehicle includes a seat for one or more persons and vehicle controls. Various safety features are also included on transport vehicle such as a raised canopy, a windshield, lights, and a front bumper.

### 1. FIELD OF THE INVENTION

The present invention relates generally to transport vehicles, and, in particular, to a vehicle for transporting and guiding a plurality of shopping carts from one location to another.

### 2. BACKGROUND

In shopping centers, and particularly in large supermarkets, it is typical for customers to transport their purchased items to their parked vehicles with shopping carts or trolleys. Rather than returning the shopping carts to supermarket, customers conveniently place their shopping carts in shopping cart collection areas that are scattered around the parking lot. Customers may alternatively decide to just leave the carts near their parking space and not go to the trouble of placing the carts in one of the collection areas. Not only do these shopping carts need to be used by other customers, but they also pose a risk of damage to the other vehicles in the parking lot. The shopping carts must therefore be periodically rounded up and manually returned to the interior of the store by employees of the store. Typically, the designated employee will form a long train of these shopping carts by nesting the carts together, each one fitting into the next adjacent one front to rear. Next, the employee pushes the resulting train by hand back into the store.

As shopping centers have continued to expand having a greater number of shoppers and huge parking lots, the job of collecting and transporting shopping carts can prove to be both time consuming and burdensome. Not only can the job be physically straining because of the combined weight of the line of shopping carts, but employees may also feel embarrassed or awkward by the act of transporting the long trains of shopping carts among the customers. Further, a long nested string of such carts is easy to form but extremely difficult to manually manipulate.

Although transport devices have been introduced to make the task of collecting and transporting shopping carts easier, these devices can be difficult to operate and still involve a great deal of manual direction by the store employees. Additionally, the devices do not include features for avoiding either inclement weather or poor safety conditions. Finally, these devices have done very little to raise the status of the job of collecting the carts. The designated employees likely take no pride or enjoyment in the act of walking behind and manually directing the long trains of nested carts.

Thus, there remains a need for an improved vehicle for collecting and transporting shopping carts that will both ameliorate the above noted disadvantages and increase the enjoyment and status of the job.

### SUMMARY OF THE INVENTION

According to its major aspects and briefly recited, the present invention is a vehicle for collecting and transporting nested shopping carts. The vehicle is a user bearing, steerable and motorized machine that is adapted to pull a string of nested shopping carts behind it. The transport vehicle is able to secure and pull the carts through the use of an alignment member extending from the rear of the vehicle and a cable and winch system that is located in the body of the vehicle. The transport vehicle further includes a cabin area, a seat for one or more persons, and vehicle controls. Various safety features are also included on transport vehicle including a raised canopy, a windshield, lights, and a front bumper.

In operation, a row of nested carts is first formed. Next the row of carts is pulled into position behind the transport vehicle. The row of carts is then secured to the transport vehicle by a winch and cable system. The winch and cable system is operated by first releasing the catch that is locking the winch so that the cable is freed to engage the last cart in the row of carts. The end of the cable includes a hook member that is attached to the handle of the last cart in the row. The winch is then operated by a crank to tighten the cable and hold the row of carts together. The winch catch is then set to hold the carts. In order to transport this row of carts back to the store, the driver operates the vehicle similarly to standard motorized vehicles by sitting in the cabin area and maneuvering the vehicle by vehicle controls and a steering means. During the transport, the row of nested carts is maintained in alignment through the use of the alignment member that is located at the rear of the transport vehicle.

A feature of the present invention is the use of a user bearing, steerable and motorized machine in combination with a raised canopy having a windshield and lights. This combination creates a safe and weather-proof environment for the driver of the transport vehicle. In particular, the raised canopy and lights alert customers and other drivers of the transport vehicle. The windshield protects the driver in the case of rain, strong wind or other inclement weather. Further, the overall enjoyment and status of the task of transporting trains of nested carts through the parking lots is improved.

Another feature of the present invention is the use of a user bearing, steerable and motorized machine in combination with a securing means and an alignment member. The securing means of the transport vehicle, which includes a winch and a hooked cable, works in combination with the alignment member to secure the nested carts to the rear of the transport vehicle in an optimal arrangement. As previously discussed, a long nested string of such carts is easy to form but extremely difficult to manually manipulate. Therefore, the securing means and alignment member help to retain the carts in the nested position during the transport, as well as minimize the roll or sway motions of the cart during the transport. Further, the use of a driven motorized vehicle essentially eliminates the need for the physical strength and dexterity typically required for the task of pushing or pulling a train of nested carts. In the present invention, persons of all sizes and/or genders may perform this task without trouble or difficulty.

These and other features and their advantages will be clear to those skilled in the art of transport vehicles from a careful reading of the Detailed Description of the Preferred Embodiments, accompanied by the following drawings.

### BRIEF DESCRIPTION OF THE DRAWINGS

FIG. 1A is a side view of a vehicle for transporting nested shopping carts with a row of nested carts secured therein according to a preferred embodiment of the present invention; and

FIG. 2A is a side view of a vehicle for transporting nested shopping carts with a row of nested carts secured and aligned therein according to a preferred embodiment of the present invention.

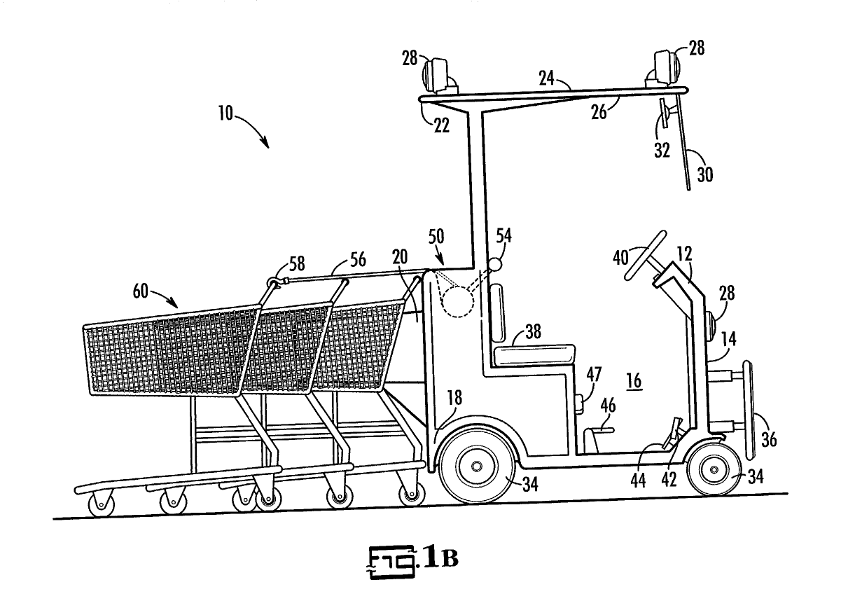

### DETAILED DESCRIPTION OF THE PREFERRED EMODIMENTS

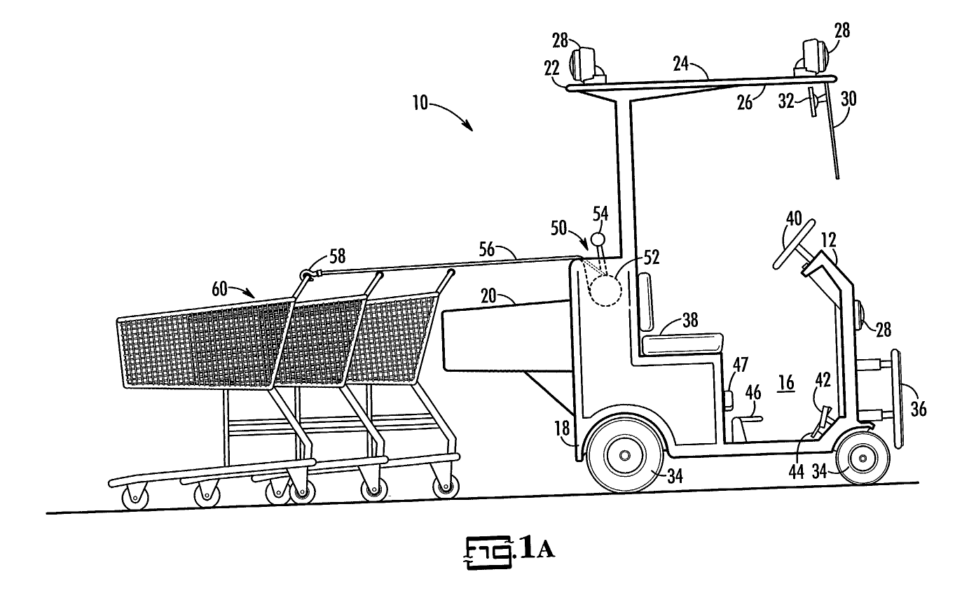

Referring now to the drawings, a transport vehicle for moving nested shopping carts is shown and is generally indicated as 10 in FIGS. 1A and 1B. As illustrated, transport vehicle 10 has a body 12 that is shaped to define a front end 14 that includes a bumper 36 and plural lights 28, a cabin area 16, and a rear end 18 that includes an alignment member 20 extending perpendicular from rear end 18. Preferably alignment member 20 and bumper 36 are made of a resilient material such as a natural or synthetic rubber or a plastic; however, other materials are contemplated for use in the present invention. Body 12 of transport vehicle 10 is supported by a series of ground engaging wheels 34.

Transport vehicle 10 further includes a canopy 22 that is supported by body 12 having a top surface 24 and a bottom surface 26. Although a number of materials are contemplated for use, canopy 22 is preferably made of fiberglass. On top surface 24 of canopy 22 are included additional plural lights 28 that face both the front and the rear of transport vehicle 10. A windshield 30 is included on bottom surface of canopy 22 that extends substantially perpendicular from canopy 22. Windshield 30 may also include a rear view mirror 32 to improve the visibility of the driver of transport vehicle 10. Preferably, canopy 22 is raised to a height greater than the height of average vehicles in a parking lot so that customers and drivers within supermarket parking lots see the top of vehicle 10 and lights 28, and are thereby alerted as to the presence of transport vehicle 10.

As previously discussed, a particular feature of the present invention is the use of a riding, steerable and motorized vehicle in combination with a raised canopy 22 having windshield 30 and plural lights 28. This combination creates a safe and weather-proof environment for the driver of the transport vehicle. Not only do raised canopy 22 and lights 28 alert customers and other drivers of the presence of transport vehicle 10, but they also improve the visibility of the driver of transport vehicle 10 by shielding driver from inclement weather and illuminating the driving path during dark conditions. Windshield 30 further protects the driver in the case of rain, strong wind or other inclement weather. Additionally, bumper 36 provides protection to body 12 of transport vehicle 10 in the case of collisions. Finally, the overall enjoyment and status of the task of transporting trains of nested carts through the parking lots is improved. Designated employees can enjoy the transporting process as they are able to sit comfortably within protected cabin area 16 of transport vehicle 10. The strength requirements of this task are also reduced by the use of vehicle 10.

Cabin area 16 of transport vehicle 10 includes a seat 38 for one or more persons and vehicle controls, including a steering wheel 40, a pedal for accelerating 42, a pedal for braking 44, a park brake 46, and a switch 47 for setting transport vehicle in forward, neutral or reverse. Transport vehicle 10 further includes a drive means, such as a battery powered electric motor (not shown) that is also operable from cabin area 16.

A securing means 50 is further included within body 12 of transport vehicle 10. Securing means 50 includes a winch 52 (shown in phantom in FIGS. 1A and 1B) that is kept in a locked position by a catch lever 54 and a cable 56 having a hook member 58. In operation, catch lever 54 on winch 52 is first released so as to free up cable 56 and hook member 58. Hook member 58 is then attached to the handle of the last shopping cart in the formed row of nested carts. Once catch lever 54 is set to hold the nested carts, the shopping carts are then favorably arranged or aligned by alignment member 20 for the transport.

Another particular feature of the present invention is the use of a riding, steerable and motorized machine in combination with securing means 50 and alignment member 20. Securing means 50 of transport vehicle 10 works in combination with alignment member 20 to secure the nested shopping carts to the rear of transport vehicle 10 in an optimal arrangement. As previously discussed, a long nested string of such carts is easy to form but extremely difficult to manually manipulate. Therefore, securing means 50 and alignment member 20 help to retain the carts in the nested position during the transport, as well as minimize the roll or sway motions of the carts during the transport. Further, the use of a driven motorized vehicle essentially eliminates the need for the physical strength and dexterity typically required for the task of pushing or pulling a train of nested carts. In the present invention, persons of all sizes and/or genders may perform this task without trouble or difficulty.

In operation, a row of nested carts 60 is first formed. Next, row of carts 60 is pulled into position behind transport vehicle 10 by the user. Row of carts is then secured to transport vehicle 10 by securing means 50. Winch 52 and cable 56 are operated by first releasing catch lever 54 that is locking winch 52 so that cable 56 is freed to engage the last cart in row of nested carts 60. The end of cable 56 includes hook member 58 that is attached to the handle of the last cart in the row. Cable 56 is then tightened to hold row of carts 60 together and catch lever 54 on winch 52 is set to a locked position. In order to transport row of nested carts 60 back to the store, the user operates vehicle 10 similarly to standard motorized vehicles by sitting in cabin area 16 and maneuvering vehicle by vehicle controls and steering wheel 40. During the transport, row of carts 60 is maintained in alignment by alignment member 20 that is located at rear end 18 of vehicle 10.

Finally, those skilled in transport vehicles for shopping carts will recognize that may substitutions and modifications can be made in the foregoing preferred embodiments without departing from the spirit and scope of the present invention.

What is claimed is:

1. A driven, wheeled and motorized vehicle for transporting a row of nested shopping carts, comprising:
a body that is shaped to define a front end, a cabin area, and a rear end;
means for securing said row to said vehicle that is contained within said body; and
a canopy that is supported by said body.

2. The vehicle as recited in claim 1, wherein said front end includes a bumper.

3. The vehicle as recited in claim 1, wherein said cabin area includes a seat.

4. The vehicle as recited in claim 1, wherein said securing means includes a winch and a cable having a hook member.

5. The vehicle as recited in claim 1, wherein said vehicle further comprises means for maintaining said row of nested shopping carts in alignment.

6. The vehicle as recited in claim 1, wherein said canopy includes lights.

7. The vehicle as recited in claim 6, wherein said lights include front-facing and rear-facing lights.

8. The vehicle as recited in claim 1, wherein said vehicle further comprises means for elevating said canopy to a height that will alert others of the presence of said vehicle.

9. The vehicle as recited in claim 1, wherein said body includes lights.

10. The vehicle as recited in claim 1, wherein said canopy includes a windshield.

11. A driven, wheeled and motorized vehicle for transporting a row of nested shopping carts, comprising:
a body that is shaped to define a front end, a cabin area, and a rear end;
means for securing said row to said vehicle that is contained within said body; and
an alignment member that is connected to said rear end of said body.

12. The vehicle as recited in claim 11, wherein said vehicle further comprises a raised canopy that is supported by said body.

13. The vehicle as recited in claim 12, wherein said canopy includes front-facing and rear-facing lights.

14. The vehicle as recited in claim 12, wherein said canopy includes a windshield.

15. The vehicle as recited in claim 11, wherein said cabin area includes a seat.

16. The vehicle as recited in claim 11, wherein said securing means includes a winch and a cable having a hook member.

17. The vehicle as recited in claim 11, wherein said front end includes a bumper.

18. A driven, wheeled and motorized vehicle for transporting a row of nested shopping carts, comprising:
a body that is shaped to define a front end, a cabin area, and a rear end;
means for securing said row to said vehicle that is contained within said body;
a canopy that is supported by said body; and
an alignment member that is connected to said rear end of said body.

19. The vehicle as recited in claim 18, wherein said canopy is raised to height sufficient to alert others of the presence of said vehicle.

20. The vehicle as recited in claim 18, wherein said alignment member extends perpendicular from said rear end of said body.
